(19) United States
(12) Patent Application Publication
(10) Pub. No.: US 2026/0259055 A1
(43) Pub. Date: Sep. 3, 2026

(54) TRAILER TOWING ASSISTANCE SYSTEM

(71) Applicant: Robert Bosch GmbH, Stuttgart (DE)

(72) Inventors: Christopher Allensworth, Waterford, MI (US); Dominik Clemenz, Farmington Hills, MI (US); Daniel Nye, Farmington Hills, MI (US); Philipp Mayer, Canton, MI (US)

(21) Appl. No.: 19/551,500

(22) Filed: Feb. 26, 2026

Related U.S. Application Data
(60) Provisional application No. 63/765,352, filed on Feb. 28, 2025.

(51) Int. Cl. G01C 21/28; B62D 15/02; G06T 7/20; G07C 5/02

(52) U.S. Cl. CPC G01C 21/28; B62D 15/029; G06T 7/20; G07C 5/02; G06T 2200/24; G06T 2207/30241; G06T 2207/30252

(57) ABSTRACT

Systems and methods related to trailer towing guidance for a vehicle. One system includes a display, a camera, a sensor, and an electronic controller. The controller includes an electronic processor configured to receive, from the camera, image data including a trailer coupled to the vehicle, receive, from the sensor, a characteristic of the vehicle, and determine, based on the image data and the characteristic, a current trajectory of the trailer. The processor is further configured to determine, based on the image data and the characteristic, one or more possible trajectories for the trailer, each of the one or more possible trajectories corresponding to a maneuver, select, from the one or more possible trajectories, a selected trajectory, and actively generate, on the display, a steering indication to a user of the vehicle including a first indication corresponding to the current trajectory and a second indication corresponding to the selected trajectory.

### RELATED APPLICATIONS

This application claims the benefit of U.S. Provisional Application No. 63/765,352 filed Feb. 28, 2025, the entire contents of which are hereby incorporated by reference.

### FIELD

Aspects presented herein relate to a trailer towing assistance system for use with a vehicle.

### BACKGROUND

Vehicles, such as automobiles, trucks, SUVs, vans, recreational vehicles, etc., may be used to tow a trailer. Some drivers may have difficulty maneuvering a trailer that they are towing.

### SUMMARY

The systems and methods herein generally relate to a vehicle trailer towing assistance system for providing a visual aid to a driver (also referred to herein as a user) of a vehicle towing a trailer.

One aspect provides trailer towing guidance system for a vehicle. The system includes a display, a camera, a sensor, and an electronic controller communicatively coupled to the display, the camera, and the sensor. The electronic controller includes an electronic processor configured to receive, from the camera, image data including a trailer coupled to the vehicle and receive, from the sensor, a characteristic of the vehicle. The electronic processor is further configured to determine, based on the image data and the characteristic, a current trajectory of the trailer, determine, based on the image data and the characteristic, one or more possible trajectories for the trailer, each of the one or more possible trajectories corresponding to a maneuver, select, from the one or more possible trajectories, a selected trajectory, and actively generate, on the display, a steering indication to a user of the vehicle including a first indication corresponding to the current trajectory and a second indication corresponding to the selected trajectory.

Another aspect provides for a method for operating a trailer towing guidance system for a vehicle. The method includes receiving, from a camera, image data including a trailer coupled to the vehicle, receiving, from a sensor, a characteristic of the vehicle, and determining, based on the image data and the characteristic, a current trajectory of the trailer. The method further includes determining, based on the image data and the characteristic, one or more possible trajectories for the trailer, each of the one or more possible trajectories corresponding to a maneuver, selecting, from the one or more possible trajectories, a selected trajectory, and actively generating, on a display, a steering indication to a user of the vehicle including a first indication corresponding to the current trajectory and a second indication corresponding to the selected trajectory.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate aspects of concepts that include the claimed systems and methods, and explain various principles and advantages of those aspects.

FIG. 1 is a block diagram of a trailer towing guidance system, according to some aspects.

FIG. 2 is a block diagram of an electronic controller of the system of FIG. 1, according to some aspects.

FIG. 3 is a flowchart of method of operating the trailer towing guidance system of FIG. 1, according to some aspects.

FIG. 4A illustrates an example of a screen displayed by a display of a human machine interface of the trailer towing guidance system of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects illustrated.

The apparatus and method components have been represented where appropriate by conventional symbols in the drawings, showing only those specific details that are pertinent to understanding the aspects so as not to obscure the disclosure with details that will be readily apparent to those of ordinary skill in the art having the benefit of the description herein.

### DETAILED DESCRIPTION

Before any aspects are explained in detail, it is to be understood that the examples presented herein are not limited in their application to the details of construction and the arrangement of components set forth in the following description or illustrated in the drawings. Aspects may be practiced or carried out in various ways. For example, while the systems and methods are generally described herein in terms of automotive systems, such systems and methods may be applied to other types of vehicle systems.

Also, it is to be understood that the phraseology and terminology used herein is for the purpose of description and should not be regarded as limiting. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

It should also be noted that a plurality of hardware and software-based devices, as well as a plurality of different structural components may be used to implement the aspects presented herein. Some aspects may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects may be implemented in software (for example, stored on non-transitory computer-readable medium) executable by one or more electronic processors. Therefore, it should be noted that a plurality of hardware and software-based devices, as well as a plurality of different structural components may be utilized to implement the aspects presented. For example, “control units” and “controllers” described in the specification can include one or more electronic processors, one or more memory modules including non-transitory computer-readable medium, one or more input/output interfaces, and various connections (for example, a system bus) connecting the components.

For ease of description, some of the example systems presented herein are illustrated with a single example of each of its component parts. Some examples may not describe or illustrate all components of the systems. Other aspects may include more or fewer of each of the illustrated components, may combine some components, or may include additional or alternative components.

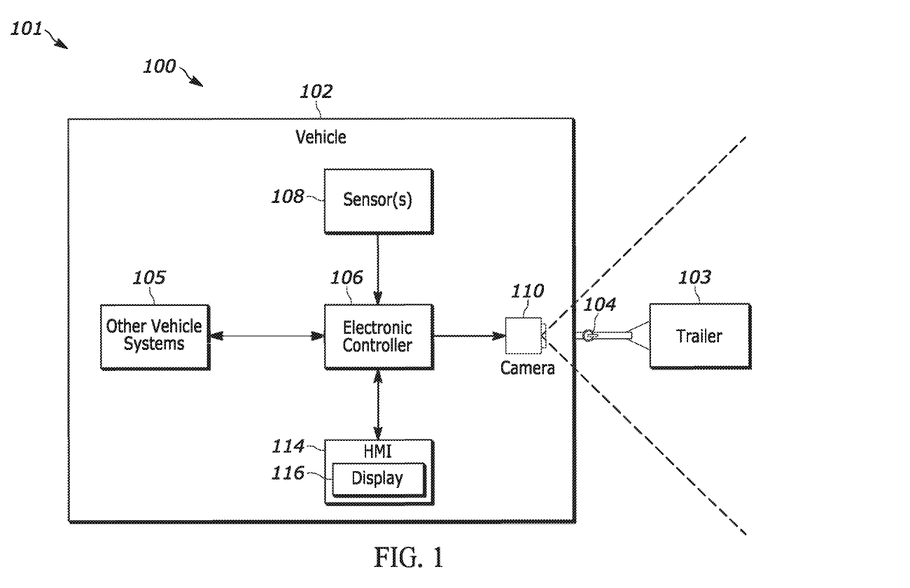

FIG. 1 is a block diagram of one example aspect of a vehicle trailer towing guidance system 100 for a vehicle 102 coupled to a trailer 103 (the collective system of which is referred to herein as trailer system 101) via a coupling 104 (for example, a trailer hitch). The system 100 includes an electronic controller 106 communicatively coupled to one or more sensors 108 and a camera 110 of the vehicle 102. Some or all of the components of the system 100 may be mounted on, or integrated into, the vehicle 102 and/or the trailer 103. In some aspects, one or more components of the system 100 are implemented on one or more systems and/or devices separate from the vehicle 102.

The vehicle 102 may be partially autonomous, meaning that the vehicle 102 is configured to drive itself with limited input from a user of the vehicle 102 or alternatively may have no automation. The systems and methods described herein may be used with any vehicle 102 capable of autonomously operating partially, being solely controlled manually by a user of the vehicle 102, or some combination of both.

In the example illustrated, the vehicle 102 includes, in addition to the vehicle trailer towing guidance system 100, other vehicle systems 105 (described in more detail below) and a human machine interface (HMI) 114 including a display 116. The systems, such as the vehicle trailer towing guidance system 100, components of the vehicle 102, along with other various modules and components therein, are electrically coupled to each other by or through one or more control or data buses, which enable communication therebetween. The use of control and data buses for the interconnection between, and communication among, the various modules and components would be known to a person skilled in the art in view of the examples and aspects described herein. In some aspects, the one or more buses include a Controller Area Network (CAN™) bus. In some aspects, the one or more buses includes an automotive Ethernet™, a FlexRay™ communications bus, or another suitable wired bus. In alternative aspects, some or all of the components of the vehicle 102 may be communicatively coupled using suitable wireless modalities (for example, Bluetooth™ or another kind of near field communication).

The sensor(s) 108 determine one or more characteristics of the vehicle 102, the trailer 103, or both and their surrounding environment. The sensor(s) 108 transmit information regarding those characteristics to the electronic controller 106. In some aspects, one or more of the sensors 108 are part of at least one of the other vehicle systems 105. The sensors 108 may include, for example, vehicle control sensors (for example, sensors that detect accelerator pedal position, brake pedal position, and steering wheel position), wheel speed sensors, vehicle speed sensors, yaw sensors, force sensors, odometry sensors, and vehicle proximity sensors (for example, camera, radar, LIDAR, and ultrasonic). In some aspects, the sensors 108 include one or more cameras (for example, the camera 110) configured to capture one or more images of the environment surrounding the vehicle 102 and/or trailer 103 according to their respective fields of view. The cameras may include multiple types of imaging devices/sensors, each of which may be located at different positions on the interior or exterior of the vehicle 102 and/or trailer 103. It should be noted that, in some aspects, the trailer 103 may also include one or more of the sensors 108.

The camera 110 is a rear-facing still image or video camera, positioned to capture images of an area to the rear of the vehicle 102, including at least a portion of the trailer 103 of the system 101. The camera 110 may be part of a back-up video camera system. Backup video cameras are generally known and will not be described in further detail. Alternative aspects include more than a single camera 110. In some aspects the camera 110 is moveable (for example, using pan, tilt, or zoom functions) to capture video images of other areas on or around the trailer system 101.

The other vehicle systems 105 include controllers, sensors, actuators, and the like for controlling aspects of the operation of the trailer system 101 (for example, acceleration, braking, shifting gears, and the like). The other vehicle systems 105 are configured to send and receive data relating to the operation of the vehicle 102 to and from the electronic controller 106.

The electronic controller 106, in some aspects, may transmit the vehicle path data to the one or more other vehicle systems 105 to automatically adjust movement of the vehicle 102 (and thus, the trailer 103). For example, the electronic controller 106 may transmit commands to a braking system, a steering system, and/or a driving system, for example, to brake, accelerate, and/or steer the vehicle 102 respectively. Alternatively (in aspects where the vehicle 102 has no automation) or additionally, the electronic controller 106 of the vehicle trailer towing guidance system 100 may utilize the display 116 to generate, from the vehicle path data and sensor telemetry received from the sensors 108, a visual of a predicted trajectory of the vehicle 102 and trailer 103.

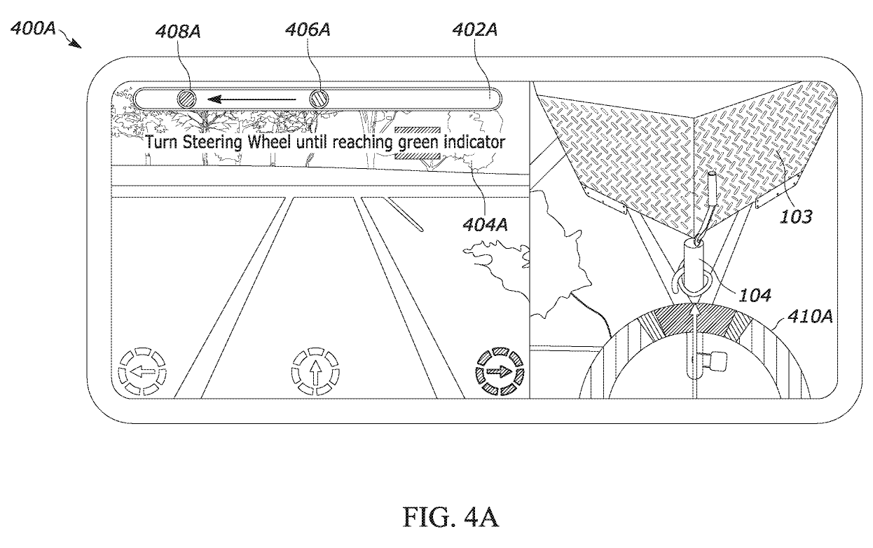

The HMI 114 provides an interface between the towing system 101 and the driver. The HMI 114 is communicatively coupled to the electronic controller 106 and receives input from the driver, receives information from the electronic controller 106, and provides feedback (for example, audio, visual, haptic, or a combination thereof) to the driver based on the received information (for example, as described in more detail below with respect to FIG. 3). The HMI 114 provides suitable input methods, for example, a button, a touch-screen display (for example, the display 116) having menu options, voice recognition, and the like for providing inputs from the driver that may be used to control certain aspects of the trailer towing guidance system 100.

The HMI 114 provides visual output, for example, graphical indicators (for example, fixed or animated icons), lights, colors, text, images (for example, from the camera 110), combinations of the foregoing, and the like. The HMI 114 includes a suitable display mechanism, for example the display 116, for displaying the visual output, for example, an instrument cluster, a mirror, a heads-up display, a center console display screen (for example, a liquid crystal display (LCD) touch screen, or an organic light-emitting diode (OLED) touch screen), or through other suitable mechanisms. In some aspects, the HMI 114 includes a graphical user interface (GUI) (for example, generated by the electronic controller 106, from instructions and data stored in the memory, and presented on a center console display screen) that enables a user to interact with the trailer towing guidance system 100. The HMI 114 may also provide audio output to the driver, for example, a chime, buzzer, voice output, or other suitable sound through a speaker included in the HMI 114 or separate from the HMI 114. In some aspects, the HMI 114 is configured to provide haptic outputs to the driver by vibrating one or more vehicle components (for example, the vehicle’s steering wheel, the driver’s seat, etc.), for example, through the use of a vibration motor. In some aspects, HMI 114 provides a combination of visual, audio, and haptic outputs. In some aspects, the HMI 114 causes the visual, audio, and haptic outputs to be produced by a smart phone, a smart tablet, a smart watch, or any other portable or wearable electronic device communicatively coupled to the vehicle 102.

The display 116 provides visual output, for example, a graphic user interface (GUI) having graphical elements or indicators (for example, fixed or animated icons), lights, colors, text, images (for example, from one or more cameras (for example, the camera 110) of the trailer system 101), combinations of the foregoing, and the like. The display 116 includes a suitable display device for displaying the visual output, for example, an instrument cluster, a mirror, a heads-up display, a center console display screen (for example, a liquid crystal display (LCD) touch screen, or an organic light-emitting diode (OLED) touch screen), or through other suitable devices.

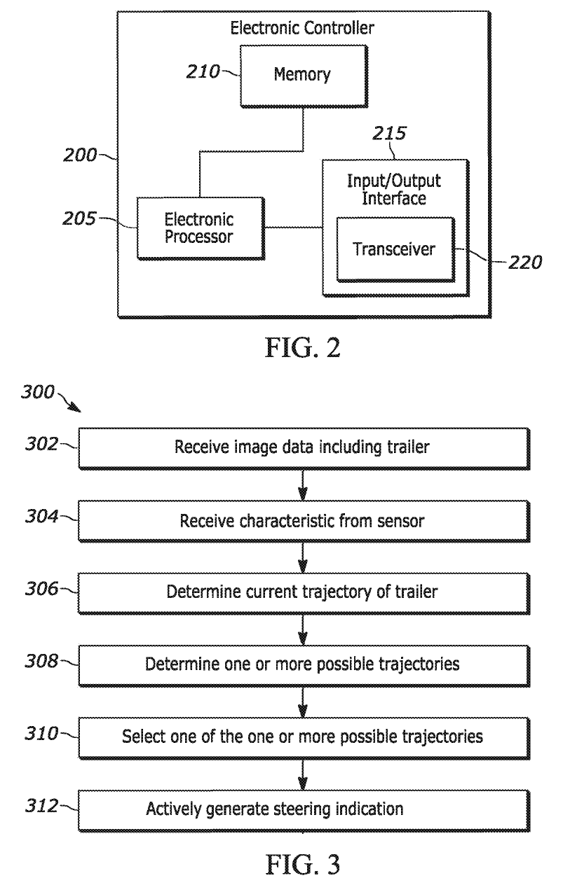

FIG. 2 is a block diagram 200 of the electronic controller 106 of the system 100 according to some aspects. The controller 106 includes, among other things, an electronic processor 205 (such as a programmable electronic microprocessor, microcontroller, or similar device), a memory 210 (for example, non-transitory, computer readable memory), and an input/output interface 215 including, in some aspects, a transceiver 220.

The electronic processor 205 is communicatively connected to the memory 210 and the input/output interface 215. The electronic processor 205, in coordination with the memory 210 and the input/output interface 215, is configured to implement, among other things, the methods described herein.

The memory 210 may be made up of one or more non-transitory computer-readable media and includes at least a program storage area and a data storage area. The program storage area and the data storage area can include combinations of different types of memory, such as read-only memory (“ROM”), random access memory (“RAM”), flash memory, or other suitable memory devices. The electronic processor 205 is coupled to the memory 210 and the input/output interface 215.

The electronic processor 205 sends and receives information (for example, from the memory 210 and/or the input/output interface 215) and processes the information by executing one or more software instructions or modules, capable of being stored in the memory 210, or another non-transitory computer readable medium. The software can include firmware, one or more applications, program data, filters, rules, one or more program modules, and other executable instructions. The electronic processor 205 is configured to retrieve from the memory 210 and execute, among other things, software for performing methods as described herein.

In some instances, the electronic processor 205 may be implemented in several independent processors (for example, programmable electronic controllers) each configured to perform specific functions or sub-functions. For example, one or more components of the electronic processor 205 may be remote from the vehicle 102 (for example, part of a remote electronic device, which is not shown). Additionally, the electronic processor 205 may contain sub-modules that include additional electronic processors, memory, or circuits for handling input/output functions, processing of signals, and application of the methods listed below. In other instances, the electronic processor 205 includes additional, fewer, or different components. Thus, the programs may also be distributed among one or more processors.

The input/output interface 215 transmits and receives information from devices external to the electronic controller 106. For example, the input/output interface 215 is configured to transmit and receive information wirelessly via a transceiver 220 or by wired connection via a suitable bus (e.g., a Controller Area Network (CAN) bus) to and from components of the system 100. The input/output interface 215 receives input (for example, from the sensors, processors, etc.), provides system output (for example, to the transceiver 220 and/or processors within the system 100, etc., or a combination of both). The input/output interface 215 may also include other input and output mechanisms (for example, one or more sensors similar to those of the vehicle 102 described above). The input/output interface 215 may also include other input and output mechanisms, which for brevity are not described herein and which may be implemented in hardware, software, or a combination of both.

In some aspects, the input/output interface includes the transceiver 220. The transceiver 220 includes, in some aspects, a radio transceiver for communicating data over one or more wireless communications networks (for example, cellular networks, satellite networks, land mobile radio networks, etc.). The transceiver 220may also provide wireless communications within the vehicle 102 using suitable network modalities (for example, Bluetooth™, near field communication (NFC), Wi-Fi™, and the like). Accordingly, the transceiver 220 communicatively couples the electronic controller 106 and, in some aspects, other components of the system 100 with one or more electronic communication devices inside and/or outside the vehicle 102. For example, the electronic processor, using the transceiver 220, can communicate with an electronic communication device (not shown) over a communications system to send and receive data, commands, and other information. The transceiver 220 includes other components that enable wireless communication (for example, amplifiers, antennas, baseband processors, and the like), which for brevity are not described herein and which may be implemented in hardware, software, or a combination of both. Some instances, the transceiver 220 includes multiple transceivers or separate transmitting and receiving components (for example, a transmitter and a receiver) instead of a combined transceiver.

It should be understood that although FIG. 2 illustrates only a single electronic processor 205, memory 210, and input/output interface 215, alternative aspects of the electronic controller 106 may include multiple processing units, memory modules, and/or input/output interfaces. It should also be noted that the vehicle 102 may include other electronic control units, each including similar components as, and configured similarly to, the electronic controller 106. In some aspects, the electronic controller 106 is implemented partially or entirely on a semiconductor (for example, a field-programmable gate array [“FPGA”] semiconductor) chip. Similarly, the various modules and control units described herein may be implemented as individual controllers, as illustrated, or as components of a single controller. In some aspects, a combination of approaches may be used.

Some or all of the components of electronic controller 106 may be dispersed and/or integrated into other devices/components of the guidance system 100 and/or the trailer system 101 (for example, in the display 116, an electronic communication device separate from the vehicle 102, and a vehicle control module (or VCM), not shown, of the vehicle 102). In some aspects, at least part of the system 100 is implemented by at least one selected from a group consisting of a smart phone, a smart tablet, a smart watch, or a portable electronic communications device communicatively coupled to the vehicle.

FIG. 3 illustrates an example method 300 of operating the vehicle trailer towing guidance system 100. As an example, the method 300 is explained in terms of the electronic controller 106, in particular the electronic processor 205. However, portions of the method 300 may be distributed among multiple devices (for example, one or more additional control units/controllers/processors of or connected to the vehicle 102 and/or trailer 103).

At block 302, the electronic processor 205 receives from the camera 110, image data. The image data includes the trailer 103 coupled to the vehicle 102. In some aspects, the image data may come from one or more other cameras (of the vehicle 102, the trailer 103, and/or from another vehicle or electronic communications device) in addition to the camera 110.

At block 304, the electronic processor receives from at least one of the sensors 108, one or more characteristics of the trailer system 101 (for example, of the vehicle 102, the trailer 103, or both). In some aspects, the characteristic includes either or both of a speed of the vehicle 102 and a steering wheel angle of the vehicle 102.

At block 306, the electronic processor 205 determines, based on the image data from the camera 110 and the characteristic(s) from the one or more sensors 108, a current trajectory of the trailer 103.

At block 308, the electronic processor 205 determines, based on the image data from the camera 110 and the characteristic(s) from the one or more sensors 108, one or more possible trajectories of the trailer 103 and, at block 310, selects a trajectory (referred to below as a selected trajectory) from the one or more possible trajectories.

Each possible trajectory corresponds to a same type of maneuver. For example, each of the possible trajectories may correspond to a turning maneuver in a forward direction of travel or a reverse direction of travel. As another example, the maneuver may be a parking maneuver (for example, parallel parking, reverse parking, etc.). As yet another example, the maneuver may be a lane merging (for example, for merging into a lane of traffic) or a lane changing maneuver. In some aspects, the maneuver is to straighten (or correct) a position/alignment of the trailer 103 with respect to the vehicle 102. This may be done, for example, in instances where the trailer 103 experiences a handling issue (for example, due to ice or slippery road conditions) such as hydroplaning, fishtailing, and/or skidding.

In some aspects, the possible trajectory (or trajectories) is based on one or more environmental factors of an environment surrounding the vehicle 102. For example, the environmental factors include a location of one or more objects/obstacles within a predetermined proximity of the trailer system 101, one or more lane markings (for example, traffic lane markings, parking lot lines, etc.), road condition (for example, icy, wet, uphill, downhill, bumpy, smooth, etc.). In some aspects, the electronic processor 205 is configured to determine one or more of the environmental factors based on information from one or more of the sensors 108 and/or the camera 110. In some aspects, the electronic processor 205 determines one or more of the environmental factors based on information from one or more other vehicles proximate to the trailer system 101 (for example, via the transceiver 220).

In some aspects, the electronic processor 205 automatically selects the selected trajectory (for example, based on information from one or more of the sensors 108, the camera 110, and/or from one or more other electronic communication devices and/or vehicles (for example, received via the transceiver 220). In some aspects, the electronic processor 205 selects the selected trajectory based on a user input (received, for example, via the HMI 114).

At block 312, the electronic processor 205 actively (for example, in real-time) generates, on the display 116, a steering indication to a driver of the vehicle 102 including a first indication corresponding to the current trajectory and a second indication corresponding to the selected trajectory. The first and second indications may each be, for example, a line indicating the respective trajectory. In some aspects, the first and second indications are a visual indication of a trailer angle determined by the electronic processor 205. The trailer angle is the yaw angle of the of the trailer 103 relative to the coupling 104 at the rear of the vehicle 102. The electronic processor 205 may determine the current trailer angle from measurement and information from the sensors 108 and/or the camera 110. For example, the electronic processor 205 may determine the trailer angle by analyzing one or more images from one or more cameras (for example, camera 110) of the vehicle 102.

In some aspects, the steering indication includes a visual prompt instructing the user to perform at least one selected from the group consisting of steering the vehicle 102, adjusting a speed of the vehicle 102, and changing a current drive gear of the vehicle 102 (for example, from a first gear to a second gear, from reverse to forward, from forward to reverse, etc.).

In some aspects, the electronic processor 205 is further configured to actively perform a comparison between the current trajectory and the selected trajectory based on information from at least one of the camera 110 and the sensor(s) 108 and modify the steering indication based on the comparison. For example, in instances where the current trajectory differs from the selected trajectory by a certain amount (for example, 20%), the electronic processor 205 may modify the steering indication to warn the user of the vehicle 102 (for example, via the display 116 and/or an audible alert, a haptic alert, etc. via the HMI 114).

In some aspects, the electronic processor 205 is configured to determine a trailer angle limit. The trailer angle limit corresponds to trailer angle value in which the trailer 103 may or will begin to jackknife with the vehicle 102. The trailer angle limit, in some embodiments, is a set predetermined value. In some aspects, the trailer angle limit is determined based on one or more aspects of the trailer system 101 (for example, one or more dimensions of the vehicle 102, the trailer 103, a speed of the vehicle 102, a weight of the trailer 103, and the like). In some aspects, in performing the comparison of block 310, the electronic processor 205 compares a current trailer angle of the trailer 103 to the trailer angle limit and generates an indication of either or both of the current trailer angle and the trailer angle limit. In some aspects, in instances where the trailer angle limit is close to or does exceed the trailer angle limit, the electronic processor 205 generates an alert to the user (for example, via the display 116 as part of the steering indication and/or an audible alert, a haptic alert, etc. via the HMI 114).

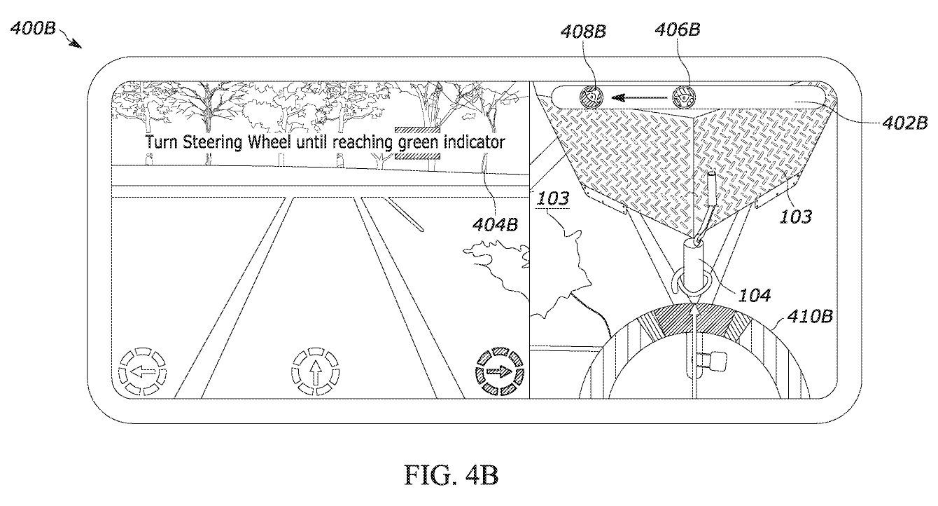

FIGS. 4A and 4B each illustrate an example screenshot 400A and 400B of the display 116 of the HMI 114 including the steering indication. In the illustrated examples of both screenshots 400A and 400B, the steering indication includes one or more elements including a guidance dial 402A, 402B and a visual command 404A, 404B prompting the user of the vehicle 102 to, in the illustrated example, turn the steering wheel of the vehicle 102. As the user turns the steering wheel, the electronic processor 205 adjusts a distance between an indication of the current trajectory (circle 406A, 406B) and an indication of the selected trajectory (circle 408A, 408B) based on a determined difference between the current trajectory and the selected trajectory as described above. As the user steers and/or drives the trailer system 101, the electronic processor 205 actively updates one or more elements of the steering indication to guide the user to perform the maneuver according to the selected trajectory.

In some aspects, the steering indication includes a steering angle dial 410A, 410B indicating a current trailer angle, a centered trailer angle (or range), and one or more trailer angle limits (or a range thereof).

In some aspects, the HMI 114 displays one or more images of the environment surrounding the trailer system 101. For example, as illustrated in FIGS. 4A and 4B, the steering indication is overlaid over an image including the trailer 103 (and the coupling 104). The screenshots 400A and 400B also include an image from a rear facing camera positioned on the rear side of the trailer 103.

In some aspects the display generated by the electronic processor 205 via the HMI 114 may be, as described above, may be displayed via a display of the vehicle 102 or on a portable electronic communications device (for example, a smart phone, a smart tablet, a smart watch, or a portable electronic device communicatively coupled to the vehicle).

In the foregoing specification, specific aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” or “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting aspect the term is defined to be within 10%, in another aspect within 5%, in another aspect within 1% and in another aspect within 0.5%. The term “coupled” as used herein is defined as connected, although not necessarily directly and not necessarily mechanically. A device or structure that is “configured” in a certain way is configured in at least that way but may also be configured in ways that are not listed.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Thus, aspects provide, among other things, a vehicle trailer towing guidance system. Various aspects are set forth in the following claims.

What is claimed is:

1. A trailer towing guidance system for a vehicle, the system comprising:
a display;
a camera;
a sensor; and
an electronic controller communicatively coupled to the display, the camera, and the sensor, and including an electronic processor configured to:
receive, from the camera, image data including a trailer coupled to the vehicle;
receive, from the sensor, a characteristic of the vehicle;
determine, based on the image data and the characteristic, a current trajectory of the trailer;
determine, based on the image data and the characteristic, one or more possible trajectories for the trailer, each of the one or more possible trajectories corresponding to a maneuver;
select, from the one or more possible trajectories, a selected trajectory;
actively generate, on the display, a steering indication to a user of the vehicle including a first indication corresponding to the current trajectory and a second indication corresponding to the selected trajectory.

2. The trailer towing guidance system of claim 1, wherein the electronic processor is further configured to:
actively perform a comparison between the current trajectory and the selected trajectory based on information from at least one of the camera and the sensor; and
modify the steering indication based on the comparison.

3. The trailer towing guidance system of claim 2, wherein the electronic processor is further configured to determine a trailer angle limit and wherein performing the comparison includes comparing a current trailer angle to the trailer angle limit.

4. The trailer towing guidance system of claim 3, wherein the electronic processor is further configured to generate an alert based on the current trailer angle and the trailer angle limit.

5. The trailer towing guidance system of claim 1, wherein the characteristic of the vehicle includes either or both of a vehicle speed and a steering wheel angle.

6. The trailer towing guidance system of claim 1, wherein at least part of the system is implemented by at least one selected from a group consisting of a smart phone, a smart tablet, a smart watch, or a portable electronic device communicatively coupled to the vehicle.

7. The trailer towing guidance system of claim 1, wherein the maneuver is a forward travel maneuver.

8. The trailer towing guidance system of claim 1, wherein the maneuver is a reverse travel maneuver.

9. The trailer towing guidance system of claim 1, wherein the maneuver is a turn.

10. The trailer towing guidance system of claim 1, wherein the electronic processor is further configured to receive, via a user interface, a user input and wherein the electronic processor selects the selected trajectory based on the user input.

11. The trailer towing guidance system of claim 1, wherein the steering indication includes a visual prompt instructing the user to perform at least one selected from the group consisting of steering the vehicle, adjusting a speed of the vehicle, and changing a current drive gear of the vehicle.

12. A method for operating a trailer towing guidance system for a vehicle, the method comprising:
receiving, from a camera, image data including a trailer coupled to the vehicle;
receiving, from a sensor, a characteristic of the vehicle;
determining, based on the image data and the characteristic, a current trajectory of the trailer;
determining, based on the image data and the characteristic, one or more possible trajectories for the trailer, each of the one or more possible trajectories corresponding to a maneuver;
selecting, from the one or more possible trajectories, a selected trajectory; and
actively generating, on a display, a steering indication to a user of the vehicle including a first indication corresponding to the current trajectory and a second indication corresponding to the selected trajectory.

13. The method of claim 12, the method further comprising actively performing a comparison between the current trajectory and the selected trajectory based on information from at least one of the camera and the sensor and modifying the steering indication based on the comparison.

14. The method of claim 13, the method further comprising determining a trailer angle limit and wherein performing the comparison includes comparing a current trailer angle to the trailer angle limit.

15. The method of claim 14, the method further comprising generating an alert based on the current trailer angle and the trailer angle limit.

16. The method of claim 12, wherein the characteristic of the vehicle includes either or both of a vehicle speed and a steering wheel angle.

17. The method of claim 12, wherein at least part of the system is implemented by at least one selected from a group consisting of a smart phone, a smart tablet, a smart watch, or a portable electronic device communicatively coupled to the vehicle.

18. The method of claim 12, wherein the maneuver is a turn.

19. The method of claim 12, the method further comprising receiving, via a user interface, a user input and selecting the selected trajectory based on the user input.

20. The method of claim 12, wherein the steering indication includes a visual prompt instructing the user to perform at least one selected from the group consisting of steering the vehicle, adjusting a speed of the vehicle, and changing a current drive gear of the vehicle.
